(19) United States
(12) Patent Application Publication
(10) Pub. No.: US 2011/0308398 A1
(43) Pub. Date: Dec. 22, 2011

(54) Coffee Machine with Securable Fine Screen

(76) Inventors: Martin Andersson, Tumba (SE); Lóránt Hajba, Gyor (HU)

(21) Appl. No.: 13/201,044

(22) PCT Filed: Feb. 11, 2010
(86) PCT No.: PCT/EP2010/000842

§ 371 Date: Aug. 11, 2011

(30) Foreign Application Priority Data
Feb. 11, 2009 (DE) 1020090116206

(51) Int. Cl. A47J 31/10

(52) U.S. Cl. 99/289 R

(57) ABSTRACT

In the area of coffee machines, especially espresso machines, it is desired to arrange a fine screen (40) in such a way that it is tightly locked in a receiving vessel (30) and carries an apparatus (41) which can be operated with objects conventionally found in a household such as a coin for example.

The invention relates to an electrically operated coffee machine which can be used for preparing espresso, cappuccino or similar hot beverages from coffee grind, comprising a fresh-water feed device, which is usually a water tank, and alternatively a direct fresh-water connection, a heating device, a hot-water or hot-steam guide means and a coupled control and/or feedback control unit, and comprising a chamber in which a vessel is inserted detachably which is used for receiving the coffee grind and carries a fine screen.

It is known in the state of the art to insert fine screens into a vessel in such a way that they can be separated from the vessel if so required.

This configuration is often characterized in a loose arrangement of the fine screen in the vessel. Simple cleaning both of the fine screen and the vessel is advantageous. Cleaning is mandatory for continual preparation of beverages because otherwise the coffee grind would clog the ultra-fine holes of the fine screen and would thus no longer ensure a quantitatively sufficient flow of hot water or steam.

Such a coffee machine is described in the German utility model DE 85 21 974.6, in which a filter insert (vessel) comprises an insertable fine screen above its floor provided with holes. The fine screen is loosely inserted or is secured in a further embodiment by means of an additional holding ring against randomly falling out. It is disadvantageous here that the apparatus is detachable in an unintentional way or has a multi-part arrangement through the holding ring. It is further disadvantageous that in the case of an inadvertent removal of the coffee grind from the fine screen the holding ring might be disposed of together with the coffee grind.

It is further disadvantageous in these coffee machines with an insertable fine screen as known from the state of the art that the various arranged retaining systems (holding rings, holding clamps, etc.) are either provided with only a very low holding force (which leads to the likelihood of unintentional detachment) or a very high holding force for detaching the fine screen, requiring a special tool.

It is the object of the present invention to provide an apparatus which can be detachably coupled and securely fastened, and which can be operated in a functionally proper way with objects conventionally found in a household.

This object is achieved by the described coffee machine according to the features of claim 1, which in addition to the main components, fresh-water feed device, fresh-water tank, heating device, hot-water or hot-steam guide means, control or feedback control unit, comprises a chamber in which a vessel is inserted which carries a fine screen which can detachably be coupled or securably fastened above the floor by means of special embodiments on the vessel.

Preferably, an apparatus is provided on the fine screen through which a movement between fine screen and vessel is initiated by which the securing movement is performed.

The apparatus is arranged in such a way in accordance with an arrangement according to the invention that objects conventionally found in a household can act as tools. Appropriately, the apparatus is provided with a slit, with the apparatus being arranged in the manner of a screw head, being connected in a fixed manner with the fine screen and being disposed in the central of the common axis of motion. It is especially advantageous here when the clearance of the slit is arranged in such a way that in addition to objects conventionally found in the household (e.g. a piece of cutlery) coined money (e.g. 1, 2 and 5 cent pieces of a thickness of 1.65 mm) can be brought into positive engagement with the slit.

After detaching the lock between fine screen and vessel, both parts should be easily separated from one another. This is not always ensured by the coffee grind that is pressed in by means of the hot water (steam).

In this context, an advantageous embodiment of the invention provides that the fine screen is received by means of a spacer in the vessel. The holding force between fine screen and vessel which is caused by the high pressure conditions is reduced to a minimum.

The fine screen is advantageously supplemented in this configuration by a removal apparatus which is arranged in such a way that by using an object again which is conventionally found in households or mentioned coined money (coin) the separation of the fine screen from the vessel can occur in a controlled manner. Useful for this purpose are beads, knobs, slits, undercuts and the like in order to offer a tool-like object a force-introducing point, especially arranged in such a way that slipping can be avoided.

The actual realization of the lock between fine screen and vessel is preferably illustrated by a corresponding possibility for locking. For example, the vessel carries on the inside of its jacket one or several knobs which engage into corresponding depressions, attached to the outside of the jacket of the fine screen, and gradually lead to a fixed press fit by the rotary movement on an associated oblique ramp. This kind of locking is like a bayonet catch and includes the possibility of a secure “detachment” of the frictional and interlocking fit in addition to a fixed, secure “fit”.

The fine screen is advantageously arranged in such a way that the entire coffee grind is received within its jacket height. The walls of the fine screen are arranged to be so high that in the case of maximum filling level the coffee grind will not come into contact with the walls of the vessel. In a special embodiment, a circumferential sealing surface between fine screen and vessel is further arranged in such a way, preferably on a protruding edge of the fine screen at the upper jacket end, that any hot fluid is supplied exclusively through an inlet opening of the vessel to the introduced coffee grind in the fine screen, passes through the same, passes through the screen with the ultra-fine passages of the fine screen, and finally leaves the coffee machine in the direction of the provided (drinking) vessel through at least one outlet opening of the vessel without the coffee grind having found any bypass between fine screen and vessel and thus undesirable residues can be found in the beverage.

It needs to be considered principally when using a circumferential sealing surface that the fine screen will not press on the floor of the vessel in such a way that fluid is obstructed entirely or partly in passing through the coffee grind because yielding of the fluid via the otherwise existing bypass is no longer possible.

Any blockage of the provided flow ducts could lead to permanent damage to the coffee machine. Preferably, means must be arranged between the contact surfaces on the floor of the fine screen and vessel in such a way that clogging of the flow ducts is prevented. These means could consist of incorporated ribs or knobs for example, but also incorporated as slit-like or trough-like depressions. Finally, differently bulged floors could prevent the blockage of the flow ducts.

The invention is now explained in closer detail by reference to drawings/drafts and an illustration, wherein:

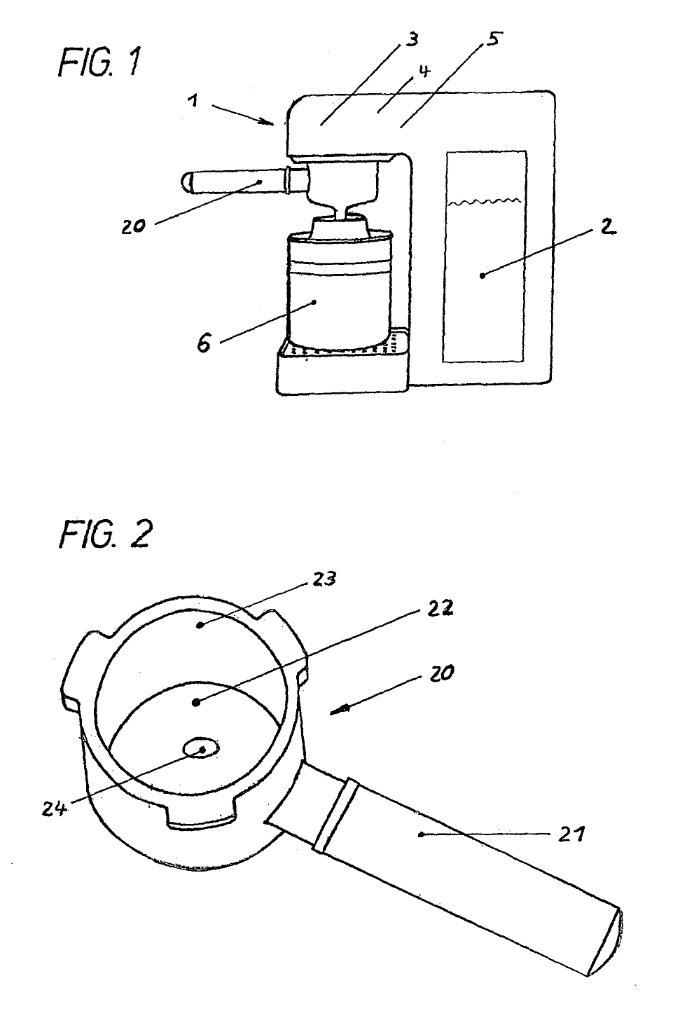

FIG. 1 shows an electrically operated coffee machine;

FIG. 2 shows a holding apparatus with a chamber that can be removed by hand;

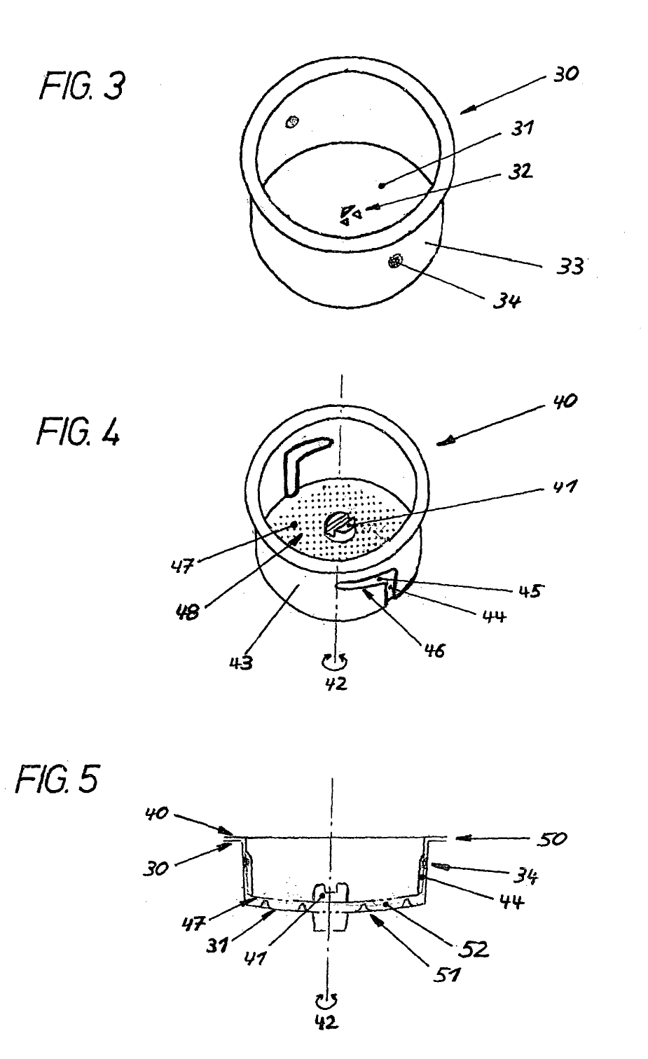

FIG. 3 shows a vessel;

FIG. 4 shows a fine screen;

FIG. 5 shows a longitudinal sectional view of vessel and fine screen in the assembled state;

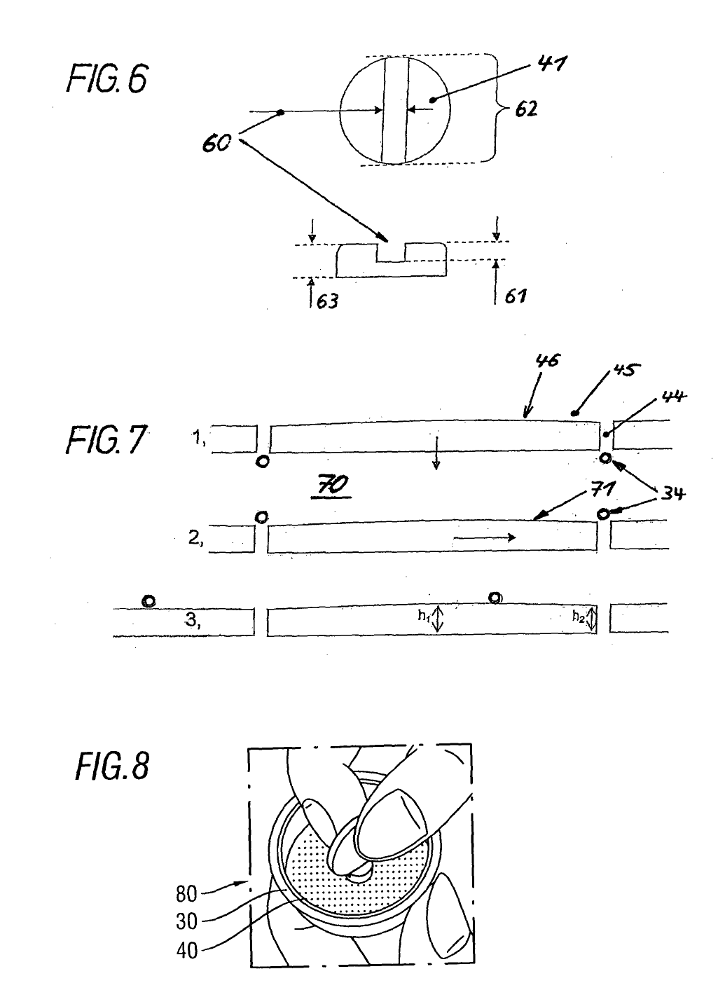

FIG. 6 shows an apparatus similar to a screw head;

FIG. 7 shows a schematic illustration of the corresponding locking device between vessel and fine screen;

FIG. 8 shows an illustration in which the fine screen can be detached from the vessel by means of a coin.

FIG. 1 shows the relevant components of an electrically operated coffee machine 1 in an overall view. In addition to the visible fresh-water tank 2, the coffee machine 1 comprises a number of components not shown in closer detail such as a heating device 3 which is used for heating the fluid up to a vaporous state of aggregation, a hot-water or hot-steam guide means 4, and a control and feedback control unit 5. Also shown are a detachably suspended holding apparatus 20 and deposited collecting container 6.

FIG. 2 shows the holding apparatus 20 with a handle 21 and a chamber 22, with the chamber 22 comprising a large open cross-sectional area 23 for the supply of hot water and a small cross-sectional area 24 in the floor for discharging the coffee extract.

FIG. 3 shows the vessel 30. It sits in the chamber 22 of the holding apparatus 20 during operation of the coffee machine 1. One or several nozzle openings 32 are visible in the floor 31 of the vessel, with an especially desired “crema” being produced with their special cross-sectional shape in preparing the coffee. Two knobs 34 are shown as recesses on the vessel jacket 33 which face towards the interior of the vessel and are shown as elevations on the inside jacket of the vessel.

FIG. 4 shows the fine screen 40 in which the coffee grind is introduced. In the center there is a screw-head-like apparatus 41. It is connected fixedly with the fine screen 40 and is fixed in the axis of motion 42. Two duct-like recesses 44 and two associated bent depressions 45 are shown on the jacket 43 of the screen, which each comprise an oblique ramp 46. The floor 47 of the fine screen further shows a plurality of minute passages 48 which are used as a flow opening and simultaneously hold back the coffee grind.

FIG. 5 shows a longitudinal sectional view of the vessel 30 in the assembled state with the fine screen 40. A circumferential sealing surface 50 is disposed between vessel 30 and the fine screen 40, so that any hot water or hot steam is guided through the coffee grind to the smallest passages 48. Means (arranged here as knobs 51) can further be seen between the vessel floor 31 and the floor 47 of the fine screen, which means act as spacers and prevent the clogging of the flow ducts 52.

FIG. 6 represents a screw-head-like apparatus 41, with the width 60 of the slit having the dimension 1.75±0.05 mm and the depth 61 of the slit having the dimension 1.7 mm. The diameter 62 of the head is arranged with 8.0 mm and the height 63 of the head with 3.2 mm. The insertion of coins into the slit of the screw-head-like apparatus 41 is thus enabled.

FIG. 7 represents the corresponding possibility for locking in three steps:

Step 1: The knobs 34 of the vessel slide first into the duct-like depressions 44 on the jacket 43 of the fine screen 40.

Step 2: As a result of the rotary movement about the common axis of motion 42, the vessel knobs 34 slide into the bent recesses 45. In this process, they slide on an oblique ramp 71.

Step 3: After passing a certain path on the oblique ramp 71, the connection between vessel 30 and fine screen 40 is ensured by means of a press fit, similar to a bayonet catch, by the rising dimension h₁>h₂.

FIG. 8 shows an illustration of the use of a coin which is brought into engagement with the screw-head-like apparatus 41 and rigidly connects the vessel 30 with the fine screen 40 by means of a rotary movement about the common axis of motion 42. They are coupled detachably with each other for cleaning purposes however.

### LIST OF REFERENCE NUMERALS

Coffee machine
Fresh-water tank
Heating device
Hot water/hot steam guide means
Control/feedback control unit
Collecting container
Holding apparatus
Handle
Chamber
Large cross-sectional area
Small cross-sectional area
Vessel
Floor of the vessel
Nozzle openings
Jacket of vessel
Knobs of vessel
Fine screen
Screw-head-like apparatus
Axis of motion
Jacket of the fine screen
Duct-like depressions
Bent depressions
Oblique ramp
Floor of the fine screen
Minute passages
Circumferential sealing surface
Knobs
Flow ducts
Width of slit
Depth of slit
Diameter of head
Height of head
Corresponding locking possibility
Oblique ramp
Coin

1. An electrically operated coffee machine which can be used for preparing espresso, cappuccino or similar hot beverages from coffee grind, comprising a chamber in addition to a fresh-water feed device and/or a fresh-water tank, a heating device, a hot-water or hot-steam guide means and a coupled control and/or feedback control unit, in which chamber a vessel is inserted detachably which is used for receiving the coffee grind and carries a fine screen, wherein the fine screen can detachably be coupled and locked with the vessel above a floor of the fine screen.

2. The coffee machine according to claim 1, wherein the fine screen is provided with an apparatus for initiating a locking motion.

3. The coffee machine according to claim 2, wherein the apparatus is arranged in the manner of a screw head.

4. The coffee machine according to claim 2, wherein the application of force for the locking motion via the apparatus is enabled by means of objects conventionally found in a household.

5. The coffee machine according to claim 2 4, wherein the apparatus comprises a slit-like receiver.

6. The coffee machine according to claim 1, wherein a receiver is inserted as a spacer between the fine screen and the vessel.

7. The coffee machine according to claim 1, wherein the fine screen comprises a removal apparatus.

8. The coffee machine according to claim 7, wherein the removal apparatus can be brought into engagement by means of objects conventionally found in a household.

9. The coffee machine according to claim 1, wherein the vessel and the fine screen have a corresponding locking feature for locking.

10. The coffee machine according to claim 9, wherein the corresponding locking feature comprises one or several knobs with associated depressions and represents a kind of bayonet catch by means of associated inclined ramps.

11. The coffee machine according to claim 1, wherein the fine screen is provided with such a high circumferential wall that the entire coffee grind is received without the wall of the vessel coming into contact with the coffee grind.

12. The coffee machine according to claim 1, wherein a circumferential sealing surface is arranged between fine screen and the vessel.

13. The coffee machine according to claim 12, wherein the sealing surface is disposed on the fine screen above a storage space of the coffee grind.

14. The coffee machine according to claim 1, wherein a flow duct is located between the floor of the vessel and the floor of the fine screen, and means are arranged between the floor of the vessel and the floor of the fine screen which prevent clogging of the flow duct.

15. The coffee machine according to claim 14, wherein the means is/are arranged in the form of ribs or knobs.

16. An electrically operated brewing machine for preparing beverages from ground coffee, the machine comprising:
a housing;
a fresh-water feed device and/or a fresh-water tank;
a water heater configured to heat water from the fresh-water feed device and/or fresh-water tank;
a chamber selectively mounted to the housing and configured to receive heated water from the water heater;
a vessel detachably inserted into the chamber, the vessel having a vessel floor and a vessel jacket extending upward from the vessel floor;
a fine screen detachably inserted into the vessel, the fine screen having a fine screen floor and a fine screen jacket extending upward from the fine screen floor, the fine screen floor and fine screen jacket forming a storage area for receiving ground coffee; and
a lock positioned above the fine screen floor for locking the fine screen to the vessel.

17. The machine according to claim 16, wherein the lock comprises a screw head having a slit sized to receive a coin.

18. The machine according to claim 16, wherein the vessel and the fine screen further comprise a bayonet locking mechanism.

19. The machine according to claim 18, wherein the bayonet locking mechanism comprises one or more knobs extending inwardly from the vessel jacket, and one or more corresponding inclined ramps formed on the fine mesh jacket.

20. The machine according to claim 16, wherein a circumferential sealing surface is arranged between the fine screen and the vessel, and the storage area is shaped such that the ground coffee does not contact the vessel.
